(19) United States
(12) Patent Application Publication
(10) Pub. No.: US 2015/0273706 A1
(43) Pub. Date: Oct. 1, 2015

(54) ACCESSORY TOOL FOR AN OSCILLATING POWER TOOL

(71) Applicant: Mario Martin, Rigaud (CA)

(72) Inventor: Mario Martin, Rigaud (CA)

(21) Appl. No.: 14/669,287

(22) Filed: Mar. 26, 2015

(30) Foreign Application Priority Data
Mar. 31, 2014 (GB) 1405698.0

(51) Int. Cl. B26B 9/02; B23D 61/00; B26D 1/00

(52) U.S. Cl. CPC B26B 9/02; B26D 1/0006; B23D 61/006; B26D 2001/006

(57) ABSTRACT

An accessory tool for an oscillating power tool, the oscillating power tool including a drive member, the accessory tool comprising: a mounting portion configured so as to be mountable to the drive member; a blade portion extending from the mounting portion, the blade portion defining a blade portion peripheral edge; the blade portion peripheral edge including first and second concave cutting portions opening respectively towards first and second directions, the first and second concave cutting portions being usable for cutting when the accessory tool is operatively mounted to the oscillating power tool, the first and second directions being angled at more than 90 degrees relative to each other.

### FIELD OF THE INVENTION

The present invention relates generally to cutting tools, and, more particularly, to an accessory cutting tool for an oscillating power tool.

### BACKGROUND

There exist many cutting tool attachments for oscillating power tools. One such known cutting tool attachment is generally represented by a plate member defining a mounting portion at one end thereof that is configured to mate with an oscillating drive member of the oscillating power tool, and a blade portion extending from the mounting portion.

Typically, the mounting portion generally defines a substantially centered mounting portion aperture that is suitably shape configured for rigidly engaging therethrough the oscillating drive member with an attachment screw or the like engaged at the distal end of the latter. The shape configuration of the mounting portion aperture is often represented by an industry standard shape that is compatible with the oscillating drive member of the oscillating power tool made by different manufacturers. The blade portion is typically represented by a flat plate member defining one or more razor sharp cutting edge portions along peripheral portions thereof.

With the cutting tool attachment attached to the oscillating drive member of an oscillating power tool, the cutting edge thereof is oscillated at a high frequency longitudinally along a perpendicularly oriented plane relative to a rotational axis of oscillation of the oscillating drive member. The oscillating frequency of commercially oscillating power tools may be typically between 5000 and 25000 oscillations per minute, with the rotational axis of oscillation rotating back and forth typically between a 0.5 and a 7 degree radial angle. These cutting tool attachments are typically usable for cutting through wood, gypsum, metal, rubber, carpets and the likes.

Some cutting tools may also be used for cutting through asphalt and composition roofing shingles attached to a support surface of a roof. For example, in a typical roof renovation context where roofing shingles must be removed in order to install new ones, the workers are generally contractors working long hours in precarious positions on substantially elevated and often steeply slanted roof surfaces.

After having roughly removed most of the roofing shingles with typically a shovel or crowbar like instrument and direct manual work, more detailed removal operations are needed in order to remove residual bits and pieces of roofing material that remains glued, nailed or otherwise attached to the support surface. Furthermore, it is sometimes required to only precisely cut portions of roofing material at a junction with a portion of a roof that does not need renovation work.

Thus, for removing the residual bits and pieces of roofing material, workers often rely on a commercially available oscillating power tool equipped with a typical cutting tool attachment as described above. With such a tool, a worker typically singlehandedly holds and manipulates the motor body of the tool, which also serves as its operational handle, in order to substantially glide the flat underside surface of the cutting tool attachment on the support surface such that the cutting edge thereof cuts through and separates the contacting surfaces between the support surface and the roofing residues. In other instances, the worker has to hold the oscillating tool sideways in order to cut through the roofing material using the cutting blade at a perpendicular angle relative to the support surface.

While the known cutting tool attachments can generally fulfill the main objective of cutting through such roofing material, they are also generally inefficient in executing this particular task.

For example, in order to maintain a relatively safe and stable body position on the roof, a worker will often have to fully stretch the arm holding the oscillating power tool for long periods at a time, in order to remove the roofing residues along distal roof support surface portions surrounding his or her stable position. The known cutting tool attachments being configured with a distally extending cutting portion, the worker needs to maintain the other end of the oscillating power tool (e.g. the motor body) at a specific angle relative to the support surface, otherwise the cutting edge may start to dig within the support surface or skim above the roofing residue. Hence, it becomes quickly weary and exhausting for the worker to maintain this specific angle of the oscillating power tool with a stretched arm.

What often further complicates this already precarious task on elevated and slanted roof surfaces resides in that the work may sometimes have to be done in particularly cold, windy and even icy weather conditions. In such conditions, even the most adherent surfaces of gloves and oscillating power tools provided with rubber covered surfaces become significantly less adherent which, in turn, requires more gripping power from the hand of the worker.

Also, this slippery effect of the cold weather on the oscillating power tool is amplified by the oscillating nature of the power tool itself since the cutting tool attachment is typically represented by an unbalanced plate member attached through a distal end thereof to the oscillating drive member of the power tool.

In view of the above, there is a need in the industry for an improved accessory tool for an oscillating power tool.

An object of the present invention is to provide such an accessory tool for an oscillating power tool.

### SUMMARY OF THE INVENTION

In a broad aspect, the invention provides an accessory tool for an oscillating power tool, the oscillating power tool including a drive member, the accessory tool comprising: a mounting portion configured so as to be mountable to the drive member; a blade portion extending from the mounting portion, the blade portion defining a blade portion peripheral edge; the blade portion peripheral edge including first and second concave cutting portions opening respectively towards first and second directions, the first and second concave cutting portions being usable for cutting when the accessory tool is operatively mounted to the oscillating power tool, the first and second directions being angled at more than 90 degrees relative to each other.

The invention may also provide an accessory tool wherein the first and second directions are angled at more than 135 degrees relative to each other.

The invention may also provide an accessory tool wherein the first and second directions are substantially opposed to each other.

The invention may also provide an accessory tool wherein the blade portion peripheral edge further includes a linking portion extending between the first and second concave cutting portions, the linking portion being a cutting portion usable for cutting when the accessory tool is operatively mounted to the oscillating power tool.

The invention may also provide an accessory tool wherein at least part of the linking portion has a substantially rectilinear configuration.

The invention may also provide an accessory tool wherein the at least part of the linking portion is substantially parallel to the first direction.

The invention may also provide an accessory tool wherein the accessory tool is substantially elongated and defines a longitudinal axis, the longitudinal axis and the at least part of the linking portion being angled at about 5 degrees to about 45 degrees relative to each other.

The invention may also provide an accessory tool wherein the linking portion merges with the first and second concave cutting portions in rounded point-shaped configurations.

The invention may also provide an accessory tool wherein the accessory tool defines a longitudinal axis and is laterally symmetrical relative to the longitudinal axis.

The invention may also provide an accessory tool wherein the blade portion peripheral edge defines a third concave cutting portion extending substantially adjacent to the first concave cutting portion and opening towards a third direction.

The invention may also provide an accessory tool wherein the first and third concave cutting portions merge together in a substantially point-shaped configuration.

The invention may also provide an accessory tool wherein the first and third directions differ from each other.

The invention may also provide an accessory tool wherein the accessory tool is substantially elongated and defines a longitudinal axis, the blade portion defining blade portion first and second end segments, the mounting portion being provided between the blade portion first and second end segments, the first and second concave cutting portions being defined in the blade portion first end segment.

The invention may also provide an accessory tool wherein the blade portion peripheral edge defines a second segment cutting portion in the blade portion second end segment, the second segment cutting portion being usable for cutting when the accessory tool is operatively mounted to the oscillating power tool.

The invention may also provide an accessory tool wherein the second segment cutting portion is substantially rectilinear.

The invention may also provide an accessory tool wherein the second segment cutting portion is substantially perpendicular to the longitudinal axis.

The invention may also provide an accessory tool wherein the blade portion peripheral edge defines a second segment side edge portion angled relative to the second segment cutting portion and merging therewith in a rounded apex configuration.

The invention may also provide an accessory tool wherein the blade portion first end segment defines a first end segment central portion and a wing extending outwardly therefrom, the first and second concave cutting portions being defined in the wing, the wing protruding at least in part laterally from the central portion.

The invention may also provide an accessory tool wherein the blade portion first and second end segments are substantially coplanar.

The invention may also provide an accessory tool wherein the mounting portion is provided in a mounting portion plane that is substantially parallel to the blade portion first and second end segments and offset relative to the blade portion first and second end segments.

The invention may also provide an accessory tool wherein the mounting portion and the blade portion first and second end segments are substantially coplanar.

The invention may also provide an accessory tool wherein the mounting portion defines a rotation axis about which the accessory tool is pivoted by the oscillating power tool when operatively mounted thereto, the accessory tool defining a center of mass, the center of mass being on the rotation axis.

The invention may also provide an accessory tool wherein the mounting portion defines a mounting aperture for receiving the drive member when the mounting portion is operatively mounted to the drive member, the mounting aperture being provided in an aperture plane, the accessory tool defining a center of mass and a center of mass axis extending through the the center of mass perpendicular to the aperture plane, the center of mass axis intersecting the mounting aperture.

The invention may also provide an accessory tool wherein at least one of the first and second concave cutting portions is beveled and sharpened.

The invention may also provide an accessory tool wherein at least one of the first and second concave cutting portions is serrated.

The invention may also provide an accessory tool wherein the mounting portion defines a mounting aperture extending therethrough for receiving the drive member, the accessory tool further defining a storage aperture extending therethrough distinct from the mounting aperture.

The invention may also provide an accessory tool wherein the accessory tool is substantially elongated and defines substantially opposed tool first and second ends substantially longitudinally opposed to each other and a longitudinal axis intersecting both the tool first and second ends, the accessory tool defining first and second end lines extending respectively through the tool first and second ends substantially perpendicular to the longitudinal axis, the first and second directions intersecting respectively the first and second end lines.

The invention may also provide an accessory tool wherein the accessory tool is substantially elongated and defines substantially opposed tool first and second ends substantially longitudinally opposed to each other, the first concave cutting portion facing generally towards the tool first end and the second concave cutting portion facing generally towards the tool second end.

The invention may also provide an accessory tool wherein the first concave cutting portion extends between first concave portion ends, the first direction bisecting tangents of the first concave portion at the first concave portion ends and the second concave cutting portion extends between second concave portion ends, the second direction bisecting tangents of the second concave portion at the second concave portion ends.

Advantageously, the proposed accessory tool is relatively inexpensive to manufacture and relatively ergonomic. The proposed accessory tool is also versatile and may be used to perform many cutting tasks, for example in the context of shingles removal in a roofing job.

The present application claims priority from UK request for patent number 1405698.0 filed Mar. 31, 2014, the contents of which is hereby incorporated by reference in its entirety.

Other objects, advantages and features of the present invention will become more apparent upon reading of the following non-restrictive description of some embodiments thereof, given by way of example only with reference to the accompanying drawings.

### BRIEF DESCRIPTION OF THE DRAWINGS

FIG. 1, in a perspective view, illustrates an embodiment of an accessory tool, according to the present invention;

FIG. 2, in a top plan view, illustrates the accessory tool shown in FIG. 1;

FIG. 3, in a partial top plan view, illustrates the accessory tool shown in FIGS. 1 and 2;

FIG. 4, in a side elevational view, illustrates the accessory tool shown in FIGS. 1 to 3, the opposite side being a mirror image thereof;

FIG. 5, in a front elevational view, illustrates the accessory tool shown in FIGS. 1 to 4;

FIG. 6, in a rear elevational view, illustrates the accessory tool shown in FIGS. 1 to 5;

FIG. 7, in an environmental, partial side elevational view, illustrates the accessory tool shown in FIGS. 1 to 6, here shown attached to an oscillating power tool and used for removing glued residues on a roof support surface;

FIG. 8, in an environmental, partial top plan view, illustrates the accessory tool shown in FIGS. 1 to 6, here shown attached to an oscillating power tool and used sideways to cut through roofing material on a roof support surface;

FIG. 9, in an environmental, partial top plan view, illustrates the accessory tool shown in FIGS. 1 to 6, here shown attached to an oscillating power tool and used for removing nailed roofing material, as well as glued residues on a roof support surface;

FIG. 10, in a perspective view, illustrates an alternative embodiment of an accessory tool, according to the present invention; and

FIG. 11, in a top plan view, illustrates the accessory tool shown in FIG. 10.

### DETAILED DESCRIPTION

The term “substantially” is used throughout this document to indicate variations in the thus qualified terms. These variations are variations that do not materially affect the manner in which the invention works and can be due, for example, to uncertainty in manufacturing processes or to small deviations from a nominal value that do not cause significant changes to the invention. These variations are to be interpreted from the point of view of the person skilled in the art. Also, the present document describes accessory tools 10 including many features. Not all embodiments of the invention include necessarily all these features and, therefore, there are embodiments of the invention in which some of the features described hereinbelow are omitted.

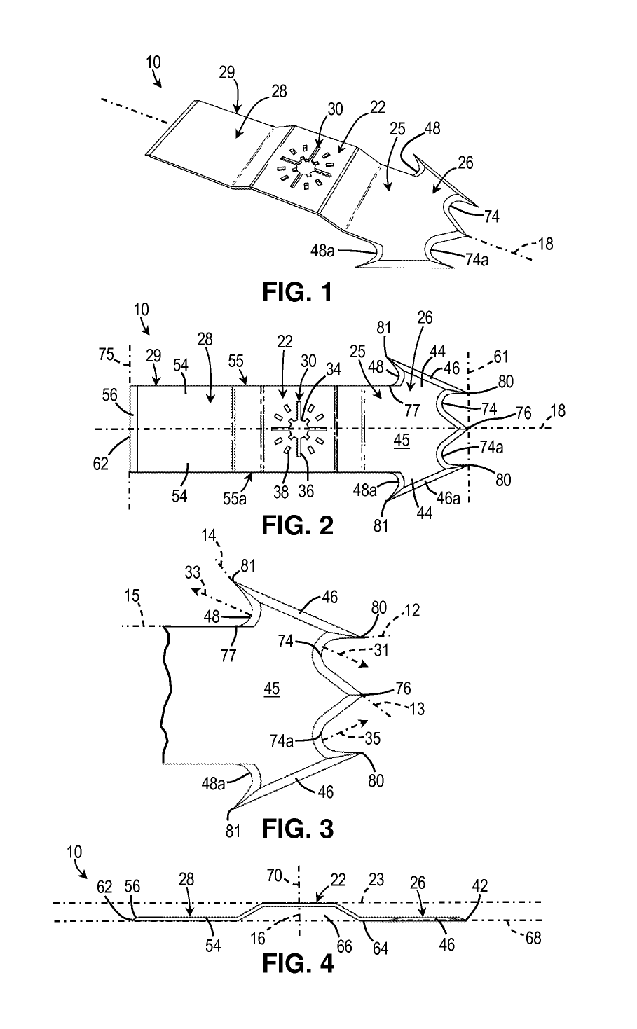

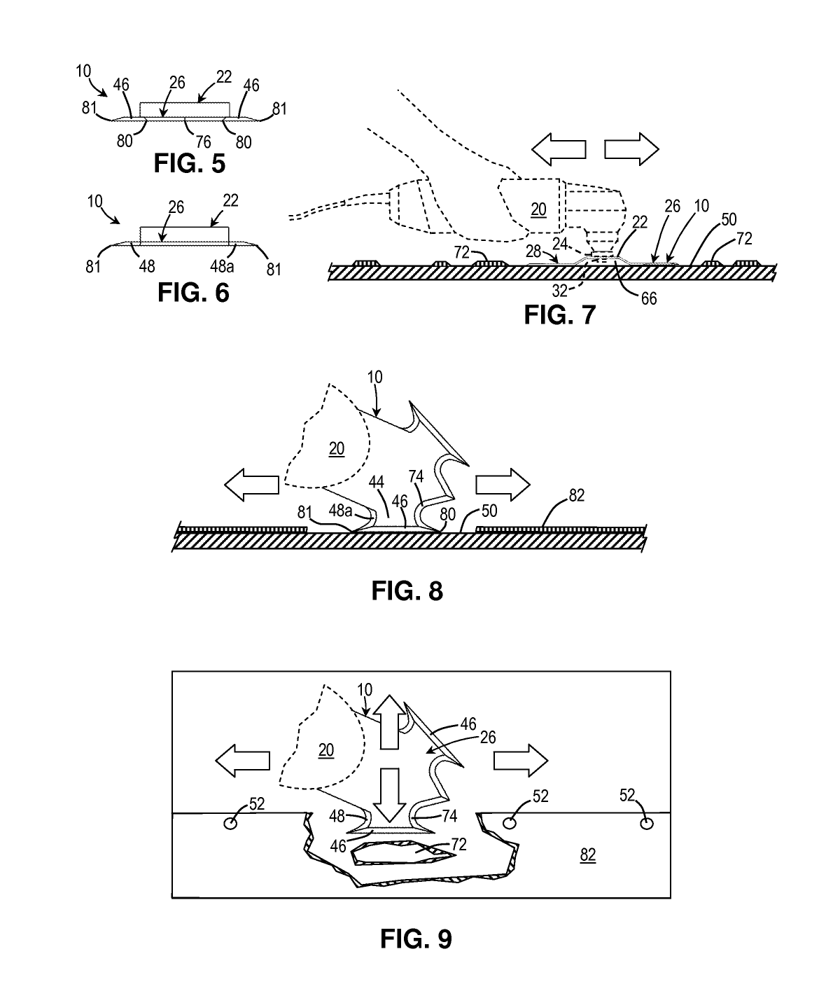

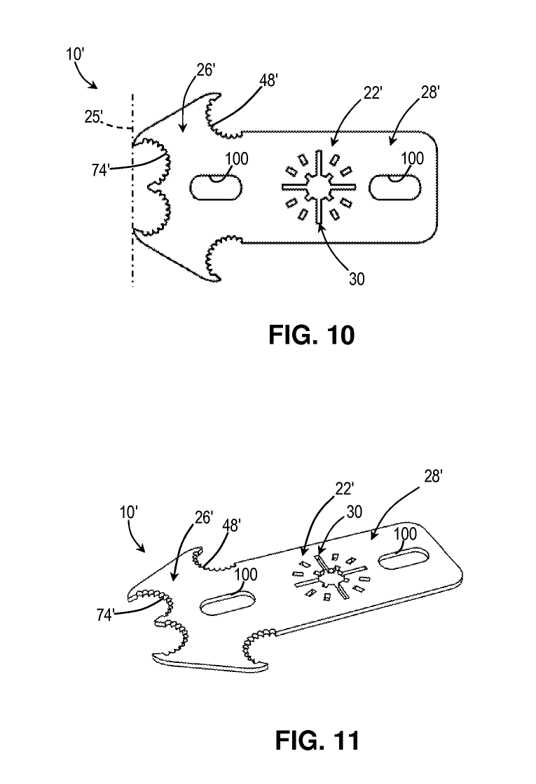

FIGS. 1 to 6 illustrate an accessory tool 10 in accordance with an embodiment of the present invention. FIGS. 10 and 11 illustrate an accessory tool 10′ in accordance with an alternative embodiment of the present invention, the differences between the two accessory tools 10 and 10′ being described in the following description. The accessory tools 10 and 10′ are usable with an oscillating power tool 20, as seen in FIGS. 7 to 9. As seen more specifically in FIG. 7, the oscillating power tool 20 including a drive member 24. In operation, the drive member 24 oscillates about a drive member pivot axis, typically at relatively high speed. As would be obvious to someone familiar with the art of cutting blade manufacturing processes, the accessory tool 10 may be formed, for example, out of a suitable metal plate member using a conventional punch-press process, a metal hardening treatment process, and an edge sharpening process.

Referring more specifically to FIGS. 1 to 3, the accessory tool 10 includes a mounting portion 22 configured so as to be mountable to the drive member 24 and a blade portion 25 extending from the mounting portion 22, the blade portion 25 defining a blade portion peripheral edge 29. In some embodiments, the blade portion peripheral edge 29 defines the contour of the entire accessory tool 10 and as such, even part of the accessory tool 10 that cannot cut are part of the blade portion. For example, in the accessory tool 10, the blade portion 25 surrounds the mounting portion 22.

The blade portion peripheral edge 29 includes first and second concave cutting portions 74 and 48 opening respectively towards first and second directions 31 and 33. A direction for the purpose of this document includes an angular orientation and is directed towards a specific direction along this angular orientation. This is to be contrasted to axes that coincide with a straight line in space, but which do not define a specific orientation along this line. The first and second concave cutting portions 74 and 48 are usable for cutting when the accessory tool 10 is operatively mounted to the oscillating power tool 20. In some embodiments, the first and second directions 31 and 33 are angled at more than 90 degrees relative to each other. In other embodiments, the first and second directions 31 and 33 are angled at more than 135 degrees relative to each other.

In yet other embodiments, the first and second directions 31 and 33 are substantially opposed to each other. Substantially opposed first and second directions 31 and 33 allow cutting first with the first concave cutting portion 74 by advancing the accessory tool 10 generally towards the first direction 31, and then, by reversing the direction of motion of the accessory tool, cutting again in the opposite direction, for example to perform work that requires a reciprocating motion, without reorienting the oscillating power tool 20. This greatly increases the ergonomics of the oscillating power tool 20 and accessory tool 10 compared to the prior art in which cutting portions facing only generally towards a single direction, or towards only slightly angled directions, are provided.

The first and second concave cutting portions 74 and 48 are configured so as to be usable to cut. In some embodiments, this is achieved when at least one of the first and second concave cutting portions 74 and 48, and typically both, is beveled and sharpened. In other embodiments, as the accessory tool 10′ shown in FIGS. 10 and 11, at least one of the first and second concave cutting portions 74′ and 48′, and typically both, is serrated. It is also within the scope of the invention to have one of the first and second concave cutting portions 74 and 48 beveled and sharpened and the other one of the first and second concave cutting portions 74 and 48 serrated.

Referring more specifically to FIG. 2, the accessory tool 10 is typically substantially elongated and defines substantially opposed tool first and second ends 76 and 62 substantially longitudinally opposed to each other and a longitudinal axis 18 intersecting both the tool first and second ends 76 and 62. The accessory tool 10 defines first and second end lines 75 and 61 extending respectively through the tool first and second ends 76 and 62 substantially perpendicular to the longitudinal axis 18. The first and second directions 31 and 33 intersect respectively the first and second end lines 75 and 61. In some embodiments, the first concave portions ends 76 and 80 are both on the first end line 75. However, in other embodiments, as shown in FIG. 11, the centrally located first concave portions end 76 is retracted from the first end line 75′.

Typically, the first concave cutting portion 74 thus faces generally towards the tool first end 76 and the second concave cutting portion 48 thus faces generally towards the tool second end 62. In informal terms, one could say that the first concave cutting portion 74 faces generally towards the front of the accessory tool 10, in some embodiments at an angle relative to the longitudinal axis 18, and that the second concave cutting portion 48 faces generally towards the back of the accessory tool 10, in some embodiments at an angle relative to the longitudinal axis 18.

In some embodiments, with reference to FIG. 3, it is helpful to describe the first and second directions 31 and 33 as follows. The first concave cutting portion 74 extends between first concave portion ends 76 and 80, the first direction 31 bisecting tangents 12 and 13 of the first concave portion 74 at the first concave portion ends 76 and 80. In some embodiments, as in the embodiment shown in the drawings, one of the first concave portion end 76 coincides with the tool first end 76. Similarly, the second concave cutting portion 48 extends between second concave portion ends 77 and 81, the second direction 33 bisecting tangents 14 and 15 of the second concave portion at the second concave portion ends 77 and 81.

In some embodiments of the invention, as shown in FIGS. 1 to 6, the accessory tool 10 is laterally symmetrical so that it is a mirror image of itself along a predetermined axis, for example the longitudinal axis 18. Accordingly, when appropriate, only one half of the accessory tool 10 is described herein, with the understanding that the other half is a substantially mirror image thereof. However, in other embodiments, this is not the case.

In some embodiments of the invention, as better seen in FIGS. 1 to 3, the blade portion peripheral edge 29 further includes a linking portion 46 extending between the first and second concave cutting portions 74 and 48. The linking portion 46 is a cutting portion usable for cutting when the accessory tool 10 is operatively mounted to the oscillating power tool 20. However, in alternative embodiments, the linking portion 46 is not able to be used to cut.

In some embodiments, at least part of the linking portion 46, and in some embodiments, the whole linking portion 46, has a substantially rectilinear configuration. For example, and non-limitingly, the at least part of the linking portion 46 that is rectilinear is substantially parallel to the first direction 31. In some embodiments, the at least part of the linking portion 46 that is rectilinear is angled at about 5 degrees to about 45 degrees relative to the longitudinal axis 18, for example at about 25 degrees, but other values a within the scope of the present invention. The generally rectilinear shape of the linking portion 46 may be used as a rectilinear guide which a worker may advantageously use to reduce the force generally used to hold the oscillating power tool 20 at a specific angle when using the accessory tool 10 oriented perpendicularly sideways along a typically planar roof support surface 50, as illustrated in FIG. 8.

In some embodiments, the linking portion 46 merges with the first and second concave cutting portions 74 and 48 in a point-shaped configuration, as seen in FIGS. 1 to 3, which may facilitate cutting for some applications. Typically, the point-shaped configuration is defined at the first and second concave portions ends 80 and 81. In other embodiments, as seen in FIGS. 10 and 11, the linking portion 46′ merges with the first and second concave cutting portions 74′ and 48′ in a rounded point-shaped configuration, which may facilitate guiding the accessory tool 10′ smoothly across surfaces. In some embodiments, the linking portion 46′ is arcuate adjacent the location at which it merges with the first and second concave cutting portions 74′ and 48′. Other configurations of the merging of the linking portion 46 merges with the first and second concave cutting portions 74 and 48 are also within the scope of the invention.

In some embodiments, with reference to FIGS. 1 to 3, the blade portion peripheral edge 29 defines a third concave cutting portion 74a extending substantially adjacent to the first concave cutting portion 74 and opening towards a third direction 35. As better seen in FIG. 3, the third cutting portion 74a is typically a mirror image of the first cutting portion 74. In some embodiments, the first and third concave cutting portions 74 and 74a merge together in a substantially point-shaped configuration, for example at the tool first end 76.

In some embodiments the first and third directions 31 and 35 differ from each other. However, in other embodiments (not shown in the drawings), the first and third directions are parallel to each other.

With reference for example to FIG. 2, in some embodiments, the blade portion 25 defines blade portion first and second end segments 26 and 28, the mounting portion 22 being provided between the blade portion first and second end segments 26 and 28. The first and second concave cutting portions 74 and 48 are defined in the blade portion first end segment 26.

Typically, the blade portion first and second end segments 26 and 28 are substantially coplanar. In some embodiments, as better seen in FIG. 4, the mounting portion 22 is provided in a mounting portion plane 23 that is substantially parallel to the blade portion first and second end segments 26 and 28 and offset relative to the blade portion first and second end segments 26 and 28. This creates room for an attachment screw 32 or other suitable fastener used to secure the accessory tool 10 to the drive member 24. However, in alternative embodiments, as seen in FIGS. 10 and 11, the mounting portion 22′ and the blade portion first and second end segments 26′ and 28′ are substantially coplanar.

In some embodiments, the blade portion peripheral edge 29 defines a second segment cutting portion 56 in the blade portion second end segment 28. The second segment cutting portion 56 is usable for cutting when the accessory tool 10 is operatively mounted to the oscillating power tool 20. In some embodiments, the second segment cutting portion 56 is substantially rectilinear, but convex, concave or other shapes for the second segment cutting portion 56 are also within the scope of the invention. The second segment cutting portion is typically substantially perpendicular to the longitudinal axis 18.

The blade portion peripheral edge 29 also defines a second segment side edge portion 54 angled relative to the second segment cutting portion 56 and merging therewith for example in a pointed apex configuration, for the accessory tool 10, or in a rounded apex configuration, for the accessory tool 10′. In some embodiments, the second segment side edge portion 54 is substantially rectilinear and part of a longer side edge portion 55 also having a substantially rectilinear configuration and extending between the second segment cutting portion 56 and the second concave cutting portion 48.

Thus the blade portion peripheral edge 29 is formed in some embodiments by the the second segment cutting portion 56, a pair of laterally opposed side edge portions 55 and 55a extending therefrom, a pair of laterally opposed second concave cutting portions 48 and 48a extending each from a respective one of the side edge portions 55 and 55a, a pair of laterally opposed linking portions 46 and 46a extending each from a respective one of the second concave cutting portions 48, a pair of laterally opposed first concave cutting portions 74 and 74a extending each from a respective one of the linking portions 46, the first concave cutting portions 74 and 74a merging together along at longitudinal axis 18.

When the blade portion second end segment 28 is present, the blade portion first end segment 26 defines a first end segment central portion 45 and a wing 44 extending outwardly therefrom, as seen for example in FIG. 2. The first and second concave cutting portions 74 and 48 are defined in the wing 44. The wing 44 protrudes at least in part laterally from the central portion 45. This configuration allows having the second concave cutting portion 48 facing generally towards the blade portion second end segment 28, while being formed in the blade portion first end segment 26.

Now referring more particularly to FIG. 2, the mounting portion 22 typically define a substantially centered mounting aperture 30 that is suitably shape configured for rigidly engaging therethrough the oscillating drive member 24 with an attachment screw 32 (seen in FIG. 7) or the like engaged at the distal end of the latter. The shape configuration of the mounting aperture 30 is typically represented by an industry standard shape configuration that is compatible with the oscillating drive member 24 of the oscillating power tool 20 made by different manufacturers.

As exemplified in in the figures, one industry standard shape configuration of the mounting aperture 30 may typically include a central aperture portion 34, superimposed with a substantially cross-shaped aperture 36. Relatively small engaging peripheral apertures 38 may be equidistantly radially distributed around the central bore portion. Other shape configurations of a mounting aperture 30 are also possible.

Referring to FIG. 4, the mounting portion 22 defines a rotation axis 70 about which the accessory tool 10 is pivoted by the oscillating power tool 20 when operatively mounted thereto. The accessory tool 10 defines a center of mass 16, the center of mass 16 being for example on the rotation axis 70. This configuration minimizes vibrations when the accessory tool 10 is used. This advantage is particularly useful in icy cold weather conditions where the adherence between the contacting surfaces of the working glove of the worker and the gripping portions of the oscillating power tool 20 is already reduced due to the resulting hardened surfaces thereof.

In some embodiments, the center of mass 16 is not on the rotation axis 70, but nevertheless is in register with the mounting aperture 30. More specifically, in these embodiments, the mounting aperture 30 is provided in an aperture plane, which typically coincides with the mounting portion plane 23. A center of mass axis, which coincides with the rotation axis 70 in the embodiment of the invention shown in the drawings, extends through the the center of mass 16 perpendicular to the aperture plane, the center of mass axis intersecting the mounting aperture 30.

In some embodiments, as seen in FIGS. 10 and 11, the accessory tool 10′ further defining at least one, and for example two storage apertures 100 extending therethrough distinct from the mounting aperture 30. The storage apertures 100 are usable to store the accessory tool 10 on a nail, a hook or other similar device.

The above-described accessory tools 10 and 10′ are multi-purpose tools that can perform many functions. For example, as illustrated in FIG. 9, with at least the blade portion first end segment 26 positioned substantially flat on a roof support surface 50, the accessory tool 10 may be moved substantially sideways therealong, in order to cut or scrape away roofing residues 72.

Also, with at least the blade portion first end segment 26 abutting flatly on the roof support surface 50, the accessory tool 10 is movable along a substantially forward and rearward movement along an axis that is substantially parallel to the rectilinear shaped linking portions 46, as illustrated in FIG. 9. Hence, roofing material residues 72 and roofing nails 52 may be cut along a longitudinal side edge of a roofing shingle 82.

Alternatively, with one of the linking portions 46 resting substantially parallelly on a typically flat roof support surface 50 with the accessory tool 10 generally perpendicular to the roof support surface 50, as illustrated in FIG. 8, a worker may not need to apply as much hand gripping force on the oscillating power tool 20 in order to cut roofing material, compared to known cutting tool attachments of the prior art.

Thus, there has been described a accessory tool 10, according to the present invention, that can be advantageously moved in forward, rearward and lateral cutting movements along a support surface, while concurrently maintaining a parallel attitude relative thereof. The accessory tool 10 of the present invention may further be used sidewardly perpendicularly in a forward and rearward cutting direction relative to a support surface, while maintaining a substantially parallel movement relative thereof.

Although the present invention has been described hereinabove by way of exemplary embodiments thereof, it will be readily appreciated that many modifications are possible in the exemplary embodiments without materially departing from the novel teachings and advantages of this invention. Accordingly, the scope of the claims should not be limited by the exemplary embodiments, but should be given the broadest interpretation consistent with the description as a whole. The present invention can thus be modified without departing from the spirit and nature of the subject invention as defined in the appended claims.

What is claimed is:

1. An accessory tool for an oscillating power tool, the oscillating power tool including a drive member, the accessory tool comprising:
a mounting portion configured so as to be mountable to said drive member;
a blade portion extending from said mounting portion, said blade portion defining a blade portion peripheral edge;
said blade portion peripheral edge including first and second concave cutting portions opening respectively towards first and second directions, said first and second concave cutting portions being usable for cutting when said accessory tool is operatively mounted to said oscillating power tool, said first and second directions being angled at more than 90 degrees relative to each other.

2. The accessory tool as defined in claim 1, wherein said first and second directions are angled at more than 135 degrees relative to each other.

3. The accessory tool as defined in claim 1, wherein said first and second directions are substantially opposed to each other.

4. The accessory tool as defined in claim 1, wherein said blade portion peripheral edge further includes a linking portion extending between said first and second concave cutting portions, said linking portion being a cutting portion usable for cutting when said accessory tool is operatively mounted to said oscillating power tool.

5. The accessory tool as defined in claim 4, wherein at least part of said linking portion has a substantially rectilinear configuration.

6. The accessory too as defined in claim 5, wherein said at least part of said linking portion is substantially parallel to said first direction.

7. The accessory tool as defined in claim 5, wherein said accessory tool is substantially elongated and defines a longitudinal axis, said longitudinal axis and said at least part of said linking portion being angled at about 5 degrees to about 45 degrees relative to each other.

8. The accessory tool as defined in claim 4, wherein said linking portion merges with said first and second concave cutting portions in rounded point-shaped configurations.

9. The accessory tool as defined in claim 1, wherein said accessory tool defines a longitudinal axis and is laterally symmetrical relative to said longitudinal axis.

10. The accessory tool as defined in claim 1, wherein said blade portion peripheral edge defines a third concave cutting portion extending substantially adjacent to said first concave cutting portion and opening towards a third direction.

11. The accessory tool as defined in claim 10, wherein said first and third concave cutting portions merge together in a substantially point-shaped configuration.

12. The accessory tool as defined in claim 10, wherein said first and third directions differ from each other.

13. The accessory tool as defined in claim 1, wherein said accessory tool is substantially elongated and defines a longitudinal axis, said blade portion defining blade portion first and second end segments, said mounting portion being provided between said blade portion first and second end segments, said first and second concave cutting portions being defined in said blade portion first end segment.

14. The accessory tool as defined in claim 13, wherein said blade portion peripheral edge defines a second segment cutting portion in said blade portion second end segment, said second segment cutting portion being usable for cutting when said accessory tool is operatively mounted to said oscillating power tool.

15. The accessory tool as defined in claim 14, wherein said second segment cutting portion is substantially rectilinear.

16. The accessory tool as defined in claim 15, wherein said second segment cutting portion is substantially perpendicular to said longitudinal axis.

17. The accessory tool as defined in claim 16, wherein said blade portion peripheral edge defines a second segment side edge portion angled relative to said second segment cutting portion and merging therewith in a rounded apex configuration.

18. The accessory tool as defined in claim 13, wherein said blade portion first end segment defines a first end segment central portion and a wing extending outwardly therefrom, said first and second concave cutting portions being defined in said wing, said wing protruding at least in part laterally from said central portion.

19. The accessory tool as defined in claim 13, wherein said blade portion first and second end segments are substantially coplanar.

20. The accessory tool as defined in claim 19, wherein said mounting portion is provided in a mounting portion plane that is substantially parallel to said blade portion first and second end segments and offset relative to said blade portion first and second end segments.

21. The accessory tool as defined in claim 19, wherein said mounting portion and said blade portion first and second end segments are substantially coplanar.

22. The accessory tool as defined in claim 1, wherein said mounting portion defines a rotation axis about which said accessory tool is pivoted by said oscillating power tool when operatively mounted thereto, said accessory tool defining a center of mass, said center of mass being on said rotation axis.

23. The accessory tool as defined in claim 1, wherein said mounting portion defines a mounting aperture for receiving said drive member when said mounting portion is operatively mounted to said drive member, said mounting aperture being provided in an aperture plane, said accessory tool defining a center of mass and a center of mass axis extending through said said center of mass perpendicular to said aperture plane, said center of mass axis intersecting said mounting aperture.

24. The accessory tool as defined in claim 1, wherein at least one of said first and second concave cutting portions is beveled and sharpened.

25. The accessory tool as defined in claim 1, wherein at least one of said first and second concave cutting portions is serrated.

26. The accessory tool as defined in claim 1, wherein said mounting portion defines a mounting aperture extending therethrough for receiving said drive member, said accessory tool further defining a storage aperture extending therethrough distinct from said mounting aperture.

27. The accessory tool as defined in claim 1, wherein said accessory tool is substantially elongated and defines substantially opposed tool first and second ends substantially longitudinally opposed to each other and a longitudinal axis intersecting both said tool first and second ends, said accessory tool defining first and second end lines extending respectively through said tool first and second ends substantially perpendicular to said longitudinal axis, said first and second directions intersecting respectively said first and second end lines.

28. The accessory tool as defined in claim 1, wherein said accessory tool is substantially elongated and defines substantially opposed tool first and second ends substantially longitudinally opposed to each other, said first concave cutting portion facing generally towards said tool first end and said second concave cutting portion facing generally towards said tool second end.

29. The accessory tool as defined in claim 1, wherein said first concave cutting portion extends between first concave portion ends, said first direction bisecting tangents of said first concave portion at said first concave portion ends and said second concave cutting portion extends between second concave portion ends, said second direction bisecting tangents of said second concave portion at said second concave portion ends.
